(19) United States
(12) Patent Application Publication
(10) Pub. No.: US 2020/0012352 A1
(43) Pub. Date: Jan. 9, 2020

(54) Discrete Type Wearable Input and Output Kit for Mobile Device

(71) Applicant: Tsai-Hsien YANG, Taoyuan City (TW)

(72) Inventor: Tsai-Hsien YANG, Taoyuan City (TW)

(21) Appl. No.: 16/028,463

(22) Filed: Jul. 6, 2018

(51) Int. Cl. G06F 3/038; G06K 9/00; G06F 3/023; G06F 3/0346; G02B 27/01

(52) U.S. Cl. CPC G06F 3/038; G06K 9/00087; H04B 1/3833; G06F 3/0346; G02B 27/0172; G06F 3/023

(57) ABSTRACT

The present invention relates to a wearable input and output kit for a mobile device. The input and output kit includes a finger-wearable input device separated from the mobile device, comprising a finger sleeve configured to wear on a thumb of a user having a fingerprint identification module to verify an identity of the user, and a button generating an input signal representing a mouse event in response to a press from an index finger of the user, and sending the input signal to the mobile device; and a wearable near-eye display device separated from the mobile device and the finger-wearable input device, receiving an output information from the mobile device and showing the output information for the user to see.

### FIELD

The present invention relates to a discrete type wearable input and output kit for a mobile device. In particular, it relates to an input and output kit combining a finger-wearable input device and a wearable near-eye display device provided for a mobile device.

### BACKGROUND

Due to rapid development and proliferation of electronic technologies, as a consequence, nowadays a variety of mobile devices, such as, smart phones, and tablet devices, have become commonplace in modern society. For most mobile devices, the components acting as the output and input interfaces are relied upon the same one, the touch screen, which combines both the touch panel for input and the display screen for output and embedded on the top side of the mobile device.

However the development of electronic technologies not only results in a widespread of the mobile devices but brings renovations and applies more high technologies to the input and output devices (interfaces) as well. A variety of novel input and output devices that are more humanity, ergonomic, comfortable for a user to user have become reality. As for the input devices, the air mouse related technologies, the finger touch based input technology, and the gestures based input with the holographic technology, have been the focus for the research and development and the popular technologies applied to renovate the input unit product. US patent publication number US 2016/0282935 A1 discloses a well-designed air mouse as an example.

As for the output devices, more research and development resources are applied to develop a revolutionary and high technology output unit product, such as, the Microsoft HoloLens product, the Epson Moverio BT-300 smart glass product, the 3D visual holographic technology and etc. Even the latest augmented reality (AR) and the virtual reality (VR) technologies are involved in the developments to try to create an astonished next generation visual output unit, which is capable of bringing a user much advanced, amazing and comfortable visual user experiences.

For the present mobile device, although it's processing capability is so strong as well as the computer, a significant shortage is that the input and output interfaces, usually the touch screen, is too small and not so convenience for most users. Very subject to the portability, most mobile devices can only configure a touch screens with a dimension in a range of 4.5 inches to 6.5 inches, as for smart phones, or a dimension in a range of 7 inches to 10 inches, as for tablets. These small size touch screen are applicable for limited operations, such as, viewing videos and images, but not suitable for dealing with daily works or complicated duties. In addition, in view of so many novel input and output devices are currently available over the market, it is about right time to provide new solution about input and output interfaces for mobile devices.

There is a need to solve the above deficiencies/issues.

### SUMMARY

Accordingly, the present invention provides a wearable input and output kit for a mobile device. The wearable input and output kit includes a finger-wearable input device separated from the mobile device including a finger sleeve configured to wear on a thumb of a user having a fingerprint identification module to verify an identity of the user, and a button generating an input signal representing a mouse event in response to a press from an index finger of the user, and sending the input signal to the mobile device; and a wearable near-eye display device separated from the mobile device and the finger-wearable input device, receiving an output information from the mobile device and showing the output information for the user to see.

Preferably, the finger-wearable input device and the wearable near-eye display device exchange data and signals with the mobile device through a wireless communication technology, which the wireless communication technology is selected from one of a Wi-Fi technology, a Bluetooth technology, a Bluetooth low energy technology, a Sub-1G technology, and a ZigBee technology.

Preferably, the finger-wearable input device further includes the finger sleeve including a front part positioned at a distal tip of the thumb and a sleeve part worn on a distal portion of the thumb; and an electronic processing module including a gyroscope motion sensor to detect a motion from the finger-wearable input device composed of a pitch action, a roll action and a yaw action occurring on a first axis, a second axis and a third axis respectively in a Cartesian coordinate system, wherein the second axis is set up to be substantively parallel with a longitudinal orientation of the distal portion, so as to alleviate torques occurring on the first axis and the third axis when the button is pressed.

Preferably, the button is configured on the front part of the finger sleeve, receives the press and acts toward a press direction in response to the press, and electrically connected with the electronic processing module, wherein the press direction is set up to be substantively parallel with a longitudinal orientation of the distal portion, so as to alleviate torques occurring on the first axis and the third axis when the button is pressed.

Preferably, the wearable near-eye display device further includes one of a sensor assembly including a plurality of electronic sensors, each of which the plurality of electronic sensors are electrically connected with a central processing unit; an attaching unit configured on the sensor assembly to cause the sensor assembly detachably attached to a head of a user; a near-eye display module separated from the sensor assembly, electrically connected with the central processing unit, and showing an information for the user to see; and a connection and position adjustment module connecting the near-eye display module and the sensor assembly and allowing a position of the near-eye display module with respect to the sensor assembly to be adjusted by the user.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1(a) is a front view schematic diagram illustrating the wearable input and output kit for a mobile device worn on a user in accordance with the present invention;

FIG. 1(b) is a side view schematic diagram illustrating the wearable input and output kit for a mobile device worn on a user in accordance with the present invention;

FIG. 2 is a schematic diagram illustrating a basic layout of circuitry in the signal adaptation module in accordance with the present invention;

FIG. 3(a) is an end-on view pinout diagram illustrating functions and arrangements for individual pins in a receptacle of USB Type-C connector adopted in the present invention;

FIG. 3(b) is an end-on view pinout diagram illustrating functions and arrangements for individual pins in a plug of USB Type-C connector adopted in the present invention;

FIG. 4(a) is a left-hand side view schematic diagram illustrating a first embodiment for the finger-wearable input device in accordance with the present invention and depicting fingers and palm of a user's right hand with the finger-wearable input device worn on the right hand;

FIG. 4(b) is a top view schematic diagram illustrating a first embodiment for the finger-wearable input device in accordance with the present invention and depicting fingers and palm of a user's right hand with the finger-wearable input device worn on the right hand;

FIG. 5(a) is a perspective schematic diagram illustrating a first embodiment for the wearable near-eye display device in accordance with the present invention and the wearable near-eye display device having a transparent display which is flipped up from the attaching unit;

FIG. 5(b) is a perspective schematic diagram illustrating a first embodiment for the wearable near-eye display device in accordance with the present invention and the wearable near-eye display device having a transparent display which is flipped out from the attaching unit;

FIG. 6 is a schematic diagram illustrating a second embodiment for the wearable near-eye display device in accordance with the present invention;

FIG. 7(a) is a front view schematic diagram depicting a up-down position tuning and a left-right position tuning of a position tuning mechanism for the wearable near-eye display device in the second embodiment in accordance with the present invention worn by a user;

FIG. 7(b) is a front view schematic diagram depicting a left-tilt position tuning of a position tuning mechanism for the wearable near-eye display device in the second embodiment in accordance with the present invention worn by a user;

FIG. 7(c) is a front view schematic diagram depicting a right-tilt position tuning of a position tuning mechanism for the wearable near-eye display device in the second embodiment in accordance with the present invention worn by a user;

FIG. 8(a) is a side view schematic diagram depicting a forward position tuning of a position tuning mechanism for the wearable near-eye display device in the second embodiment in accordance with the present invention worn by a user;

FIG. 8(b) is a side view schematic diagram depicting a backward position tuning of a position tuning mechanism for the wearable near-eye display device in the second embodiment in accordance with the present invention worn by a user;

FIG. 9(a) is a side view schematic diagram depicting a flip-up position of a position tuning mechanism for the wearable near-eye display device in the second embodiment in accordance with the present invention worn by a user; and

FIG. 9(b) is a front view schematic diagram depicting a flip-down position of a position tuning mechanism for the wearable near-eye display device in the second embodiment in accordance with the present invention worn by a user.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

The present disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B. The tem “discrete type” used in the claims and specification is referred to as “split type” or “separated type” as well and equivalently.

A part of the present disclosure is based on and partly uses technologies disclosed in U.S. utility Pat. No. 9,678,349 B2, U.S. utility patent application Ser. No. 15/676,001 allowed by USPTO, and U.S. utility patent application Ser. No. 16/027,412. The above US utility patent and applications have the Applicant the same as this application does and are incorporated into this application by reference as if fully set forth herein.

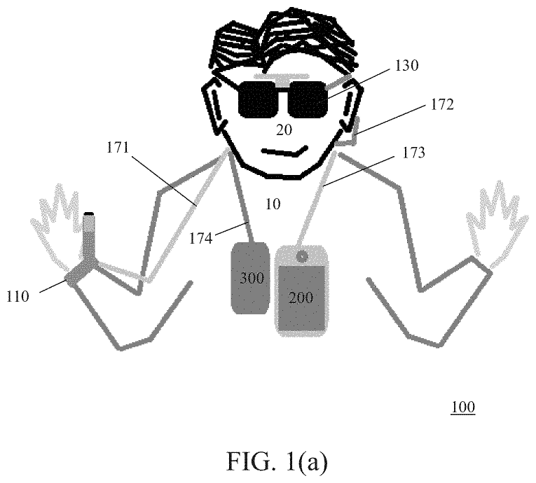

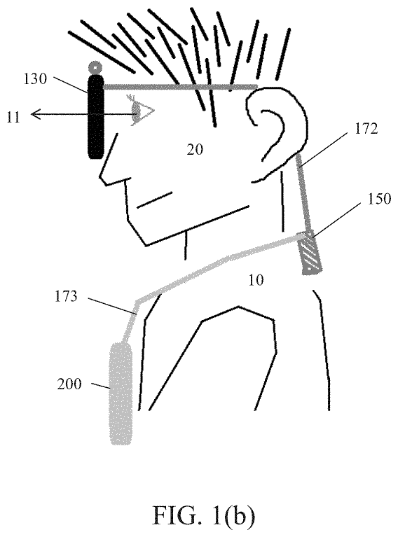

FIG. 1(a) is a front view schematic diagram illustrating the wearable input and output kit for a mobile device worn on a user in accordance with the present invention; and FIG. 1(b) is a side view schematic diagram illustrating the wearable input and output kit for a mobile device worn on a user in accordance with the present invention. The present wearable input and output kit 100 includes a finger-wearable input device 110 and a wearable near-eye display device 130, and a signal adaptation module 150. The finger-wearable input device 110 and the wearable near-eye display device 130 are designed to be worn on a user 10 and used as the input and output interfaces for the mobile device 200.

The finger-wearable input device 110 is designed to be worn on a user's a thumb, and the wearable near-eye display device 130 is designed to place a display on a head 20 of the user 10 and in front of a line of sight 11 of the user 10. The finger-wearable input device 110 is electrically connected to the signal adaptation module 150 through the transmission cable 171, and the wearable near-eye display device 130 is electrically connected to the signal adaptation module 150 through the transmission cable 172. The signal adaptation module 150 is electrically connected to the mobile device 200 through the transmission cable 173. That is, the finger-wearable input device 110 and the wearable near-eye display device 130 are electrically connected to the mobile device 200 through the signal adaptation module 150. In addition, a power bank 300 is electrically connected to the signal adaptation module 150 through a transmission cable 174.

Preferably, the mobile device 200, the signal adaptation module 150, and the transmission cables 171, 172, 173, 174 all adopt the universal serial bus (USB) standard as the connection interface to electrically connect, exchange data, and supply power with each other. There are multiple versions of USB standards include a USB 1.x, a USB 2.0, a USB 3.x, a USB Type-A, a USB Type-B, a USB Type-C, a standard USB, a mini USB, a micro USB, and a combination thereof. In general, a USB based connector includes a USB defined receptacle and a corresponding USB defined plug. The various devices in the present invention, such as, the mobile device 200, and the signal adaptation module 150, are preferably designed to have incorporated the USB defined receptacles as the connection ports, as well as the cable ends, such as, the transmission cables 171, 172, 173, and 174, each of which the transmission cables 171, 172, 173, and 174 have incorporated a corresponding USB defined plugs at the cable ends.

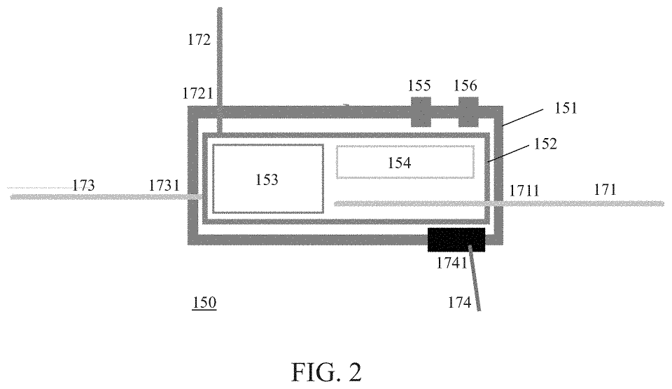

FIG. 2 is a schematic diagram illustrating a basic layout of circuitry in the signal adaptation module in accordance with the present invention. The circuitry used in the signal adaptation module 150 at least includes a housing 151, a circuit board 152, a signal adaptation integrated circuit (IC) chip 153 bonded on the circuit board 152, and a USB hub IC chip 154 bonded on the circuit board 152 as well. There are multiple USB based connection ports 1711, 1721, 1731, and 1741 built on the housing 151 and the circuit board 152, each of which ports are corresponding to the transmission cables 171, 172, 173, and 174 based on USB standard respectively, and used for accepting the USB standard based plugs on the USB based transmission cables 171, 172, 173, 174. There are more additional ports configured the housing 151 and the circuit board 152, such as, a cam port 155 for a webcam, and a phone port 156 for earphone and microphone.

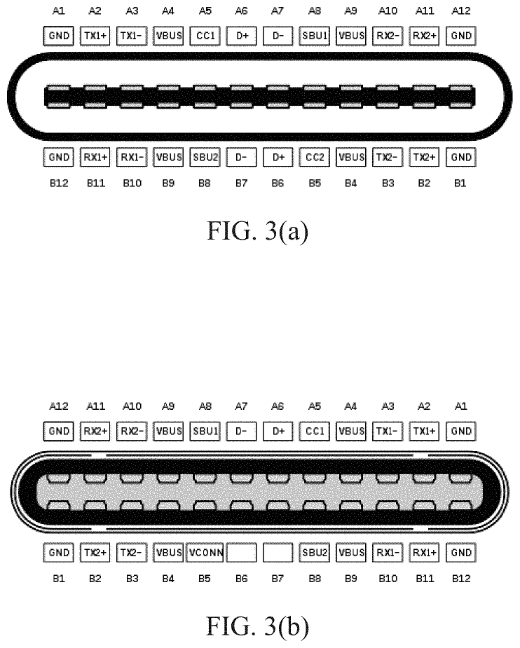

FIG. 3(a) is an end-on view pinout diagram illustrating functions and arrangements for individual pins in a receptacle of USB Type-C connector adopted in the present invention; FIG. 3(b) is an end-on view pinout diagram illustrating functions and arrangements for individual pins in a plug of USB Type-C connector adopted in the present invention. Typically, a USB standard based connector includes a USB defined receptacle and a corresponding USB defined plug. Among above multiple USB standards, the USB Type-C, also known as the USB-C, should be the most promising one in the future, and is distinguished by its two-fold rotational-symmetrical connector. In addition, As compared to a conventional micro USB standard, which is a 5-pin USB connector system, the USB Type-C is a 24-pin USB connector system. Therefore a USB Type-C connector is able to support the high data rate transmission, has pins acting as DisplayPort (eDP) for exchanging MHL or HDMI signals. Therefore massive data, in particular the graphic information, are able to be exchanged a massive data through the USB Type-C 24-pin USB connector system between devices with relatively high data rate.

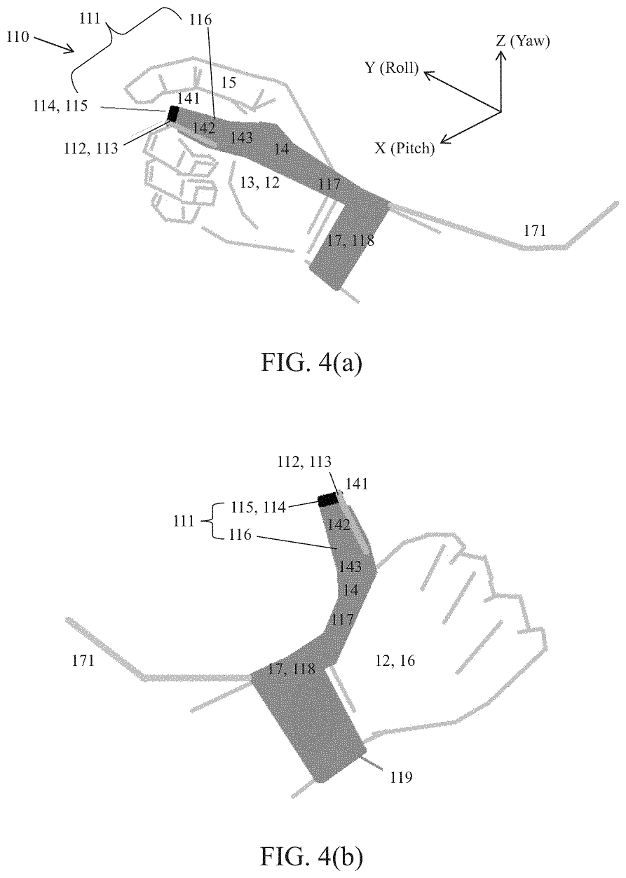

FIG. 4(a) is a left-hand side view schematic diagram illustrating a first embodiment for the finger-wearable input device in accordance with the present invention and depicting fingers and palm of a user's right hand with the finger-wearable input device worn on the right hand; FIG. 4(b) is a top view schematic diagram illustrating a first embodiment for the finger-wearable input device in accordance with the present invention and depicting fingers and palm of a user's right hand with the finger-wearable input device worn on the right hand.

The finger-wearable input device 110 includes a finger sleeve 111, a fingerprint identification module 112, a gyroscope sensor 113, a button 114, a front part 115, a sleeve part 116, a palm strap 117, a wrist strap 118 and a near field communication module 119. The right hand 12 of the user 10 consists of the palm 13, the thumb 14, the index finger 15, the back 16 of the right hand 12, and the wrist 17, wherein the thumb 14 consists of the distal tip 141, a distal portion 142 (phalanx) and a proximal portion 143 (phalanx).

The finger-wearable input device 110 is currently worn on the right hand 12 of the user 10, in which the finger sleeve 111 is worn on the thumb 14 of the user 10. The finger sleeve 111 further includes the front part 115 which is positioned at the distal tip 141 of the thumb 14 and the sleeve part 116 which is worn on the distal portion 142 (phalanx) and the proximal portion 143 (phalanx) of the thumb 14. The wrist strap 118 includes a first band that incorporates a hook pad at its end and a second band that incorporates a loop pad at its end, wherein the hook pad is detachably attached to the loop pad to cause the wrist strap 118 capable of detachably being secured on the wrist 17 of the user 10. The finger sleeve 111 and the wrist strap 118 are firmly connected through the palm strap 117, such that the finger-wearable input device 110 is capable of detachably being secured on the wrist 17 of the user 10. The finger sleeve 111, the palm strap 117 and the wrist strap 118, are preferably made of an elastic fabric.

An electronic processing module includes the fingerprint identification module 112 and the gyroscope sensor 113 is incorporated in the finger sleeve 111. When the finger-wearable input device 110 is worn on a user's thumb, the fingerprint identification module 112 automatically senses the fingerprint of the thumb, to verify identity of the user to determine whether the user is authorized, registered, or permitted to operate the finger-wearable input device 110.

The gyroscope sensor 113 included in the electronic processing module is used to detect a motion composed of a pitch action, a roll action and a yaw action occurring on a X axis (a first axis), a Y axis (a second axis) and a Z axis (a third axis) respectively in a Cartesian coordinate system based on a Lagrangian field theory moving with the observation point, the finger-wearable input device 110, which the motion is sourced from the finger-wearable input device 110 driven by the thumb 14 of the user 10 and can form a series of tracks in the air to move a cursor on the screen of the mobile device. A near field communication module 119 electrically connected to the electronic processing module is optionally configured on the wrist strap 118 for the convenience of the user 10 to use the mobile payment.

In this embodiment, the Lagrangian field theory is employed to define three axes in Cartesian coordinate system used for the gyroscope sensor 113 in the finger-wearable input device 110. That is, the observation point and the point of the origin of the Cartesian coordinate system is always positioned on the device 110 and follow it as it moves through space and time. Accordingly, it defines an axis along the longitudinal direction as the X axis, and an action while the device 110 revolves or pitches based on the X axis as the pitch action, defines an axis along the lateral direction as the Y axis, and an action while the device 110 revolves or rolls based on the Y axis as the roll action, and defines an axis along the vertical direction as the Z axis, and an action while the device 110 revolves or yaws based on the Z axis as the yaw action.

Furthermore, a button 114 is configured on the front part 115, electrically connected with the electronic processing module, receives a press from the index finger 15 of the user 10 and acts toward a press direction in response to the press. The button 114 is used to generate an input signal representing a mouse event, in response to the press from the index finger 15, and sends an input signal to the mobile device. Since the finger-wearable input device 110 can move a cursor on the screen and generate an input signal representing a mouse event, it is also termed as the air mouse.

In the present invention, a spatial arrangement for the Y axis, the press direction, and the longitudinal orientation of the distal portion 142 of the thumb 14 is particularly managed as follows. In order to alleviate and mitigate the roll action occurring on the Y axis and torques occurring on the X axis and the Z axis when the button 114 is pressed, both the Y axis defined in the gyroscope sensor 113 and the press direction the button 114 moves toward when receiving a press, are set up to be substantively parallel with the longitudinal orientation of the distal portion 142 of the thumb 14, or the Y axis is set up to be substantively parallel with a longitudinal orientation of the distal portion 142, or the press direction is set up to be substantively parallel with a longitudinal orientation of the distal portion 142. Thus when the user 10 presses the button 114, there are almost none of pitch actions or yaw actions additionally occurring on the respective X axis and Z axis. That is an operation to press the button 114 can almost cause none of torques to the X axis and Z axis. Hence the finger-wearable input device 110 owns excellent operative stability, as compared with the conventional no matter the air mouse or the some equivalent devices else.

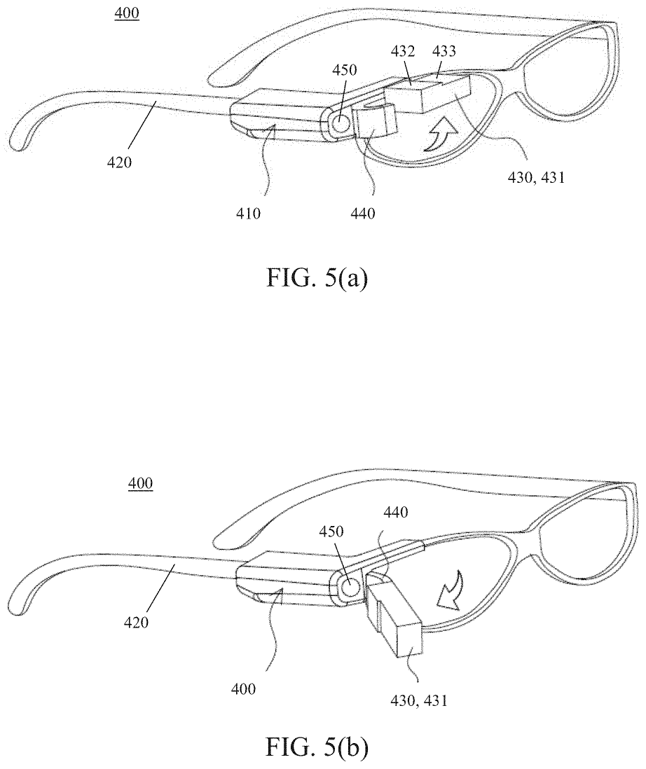

FIG. 5(a) is a perspective schematic diagram illustrating a first embodiment for the wearable near-eye display device in accordance with the present invention and the wearable near-eye display device having a transparent display which is flipped up from the attaching unit; and FIG. 5(b) is a perspective schematic diagram illustrating a first embodiment for the wearable near-eye display device in accordance with the present invention and the wearable near-eye display device having a transparent display which is flipped out from the attaching unit.

The wearable near-eye display device 400 includes an main housing 410 containing an electronic processing module, an attaching unit 420, a near-eye display module 430 and a rotatable connection unit 440 (a flipable connection unit). The main housing 410, the near-eye display module 430 and the rotatable connection unit 440 are configured on the attaching unit 420. The attaching unit 420 is preferably a spectacle-based frame. The wearable near-eye display device 400 is detachably worn on a user's head just like simply wearing glasses.

A micro camera lens 450 is configured inside a containing space (not shown) provided by the main housing 410. The main housing 410 is made of, such as, plastic or alloy, and is used for providing the multiple units and modules to be assembled therein. The electronic processing module in the main housing 410 includes such as, an 9-axis electronic motion sensor module, a 3-axis electronic compass, a 3-axis electronic gyroscope, a 3-axis electronic accelerometer, a micro processor module, an active micro power module (a battery, for instance), a wireless communication module, the micro camera lens 450 and so on therein. The micro camera lens 450 has a line of camera sight and is preferably configured in such way that the line of camera sight is substantively parallel to a user's line of sight, to record a scene whatever user sees.

The near-eye display module 430 is a transparent type see-through display 431 and a user can still see the actual surrounding environment (reality world) through the see-through display 431, while the static or the dynamic virtual digital contents is shown on the transparent display. The near-eye display module 430 preferably belongs to a head-mounted display (HMD). In this embodiment, the see-through display 431 includes an optical imaging engine 432 and a transparent prism 433.

The optical imaging engine 432 includes an imaging chip functioned upon either an active quantum dot technology (as disclosed in U.S. Pat. Nos. 8,508,830 B1 or 8,582,209 B1, for instance), a digital light processing (DLP) based technology or a liquid crystal on silicon (LCOS) based technology. The digital contents to be shown are generated first generated from the optical imaging engine 432 and then projected to the transparent prism 433. The transparent prism 433 acts as a transparent screen and is formed with a concave reflector to provide the digital contents to re-image on the transparent prism 433. When the user sees the digital contents to be shown on the transparent prism 433 and in the meanwhile the user can still see the scene of reality world like a background appearing behind the shown digital contents.

However, although the see-through display 431 is a transparent screen, the digital contents shown on the transparent display may inevitably block or shelter a part of user's sight of vision since under an regular use status, the see-through display 431 appears in front of the user's both eyes. Hence, while the device is in use, particularly a user is in movement or walking, a safety issue is raised accordingly resulted from a block of a user's sight of vision.

Thus, a rotatable connection unit 440 (a flipable connection unit) is used for rotatably/flipably linking both the near-eye display module 430 and the main housing 410. For instance, the rotatable connection unit 440 is preferably a hinge-based component or a flipable connection component. Via the filpable linkage of the rotatable connection unit 440, the near-eye display module 430 can be flipped, rotated or moved away from the user's eyesight. For instance, the near-eye display module 430 is capable of being flipped up to an upper side of the frame, as shown in FIG. 5(a), or rotated to a lateral side, as shown in FIG. 5(b), of the spectacle frame, and user can regain the original full range of field of vision.

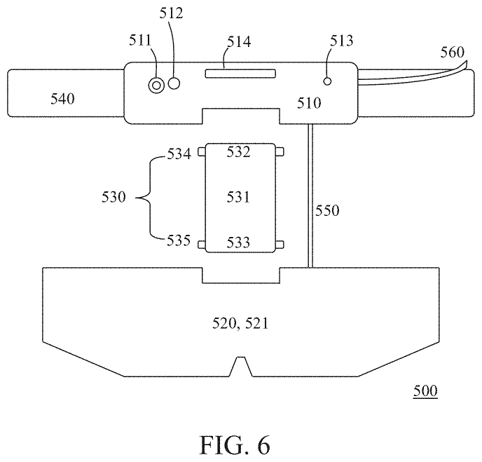

FIG. 6 is a schematic diagram illustrating a second embodiment for the wearable near-eye display device in accordance with the present invention. The present wearable near-eye display device 500 includes a sensor assembly 510, a near-eye display module 520, a connection and position adjustment module 530, and an attaching unit 540. The sensor assembly 510 includes a variety of electronic sensors, such as, an image sensor, a voice sensor, a camera lens, a gyroscope sensor, an accelerometer, a magnetometer, a barometer, an altimeter, a barometric altimeter, a light sensor, a motion sensor, a temperature sensor, an electronic compass, or an infrared sensor. In this embodiment, a camera 511, a flash light 512, a micro phone 513, and a headlight 514 is configured on the sensor assembly 510, and the sensor assembly 510 is electrically connected to a main board module and a battery module separated from the sensor assembly 510 through the transmission cable 560.

The near-eye display module 520 is preferably a transparent display, a see-through display 521 that a user can still see the actual surrounding environment of reality world like a background appearing behind the digital contents shown on the see-through display 521, while the user is wearing the near-eye display module 520 and seeing the static or the dynamic digital contents shown on the see-through display 521. The near-eye display module 520 preferably belongs to a kind of a head-mounted display (HMD) device. The near-eye display module 520 is electrically connected with the sensor assembly 510 through a flexible bus line 550, which is a group of electric wires used to transmit data or electronic signals, or a transmission cable between the sensor assembly 510 and the near-eye display module 520.

The connection and position adjustment module 530 includes, for example, a connection arm 531 which has a first end 532 and a second end 533 at which a first pivot joint 534 and a second pivot joint 535 are disposed respectively. The first pivot joint 534 on the first end 532 is used for connecting to the sensor assembly 510 and the second pivot joint 535 on the second end 533 is used for connecting to the near-eye display module 520. By the linkage of the connection and position adjustment module 530, the near-eye display module 520 is suspended on, but separated from the sensor assembly 510.

The attaching unit 540 is configured to the sensor assembly 510 to cause the sensor assembly module 510 capable of being detachably (separable, removable) attached to a user's head 20, in particular, a user's forehead. Typically the attaching unit 540 is a support and securing structure capable of detachably securing the sensor assembly 510, the near-eye display module 520 and the connection and position adjustment module 530, onto the user's head 20 and capable of causing the near-eye display module 520 placed in the user's line of sight at an appropriate distance from the user's eyes. The attaching unit 540 is made of soft, flexible, or elastic materials and preferably a headband, a sweatband, a size band, an adjustable belt, an elastic support arm, a flexible support frame, a support temple or a silicon support.

Thus, the digital information can be presented to the near-eye display module 520 and then projected into the user's eyes. Preferably, since the see-through display 521 is transparent or semi-transparent, the information shown on the see-through display 521 is superimposed on the actual scene beyond the see-through display 521 and in front of the user.

Typically the connection arm 531, the first pivot joint 534, and the second pivot joint 535 form and provide a flipable based position adjustable mechanical structure for the near-eye display module 520 with respect to the sensor assembly 510. One of multiple embodiments for the connection and position adjustment module 530 is disclosed in U.S. Pat. No. 9,678,349 B2 which has the Applicant the same as the present invention does and is incorporated into this application by reference as if fully set forth herein. The near-eye display module 520 is disposed on the sensor assembly 510 through the connection and position adjustment module 530. Therefore, a user can easily flip up the near-eye display module 520 to have a clear and unscreened field of eyesight.

The electronic modules including the sensor assembly 510 and the near-eye display module 520, are electrically connected to a central processing unit which is separated from the sensor assembly 510 and the near-eye display module 520 and configured on a main board module, and a battery module which is separated from the sensor assembly 510, the near-eye display module 520, and the central processing unit. The sensor assembly 510, the near-eye display module 520, the central processing unit, the main board module and the battery module are separated from each other but electrically connected with each other. The central processing unit, the main board module and the battery module are deployed and well hidden on a clothing accessory worn on a user.

The main board module includes the central processing unit (CPU), a memory module, a wireless communication module, a USB interface, a HDMI interface, a NFC interface, a uSIM slot, a uSD card slot, an ear phone socket, a signal line socket and a power line socket. The main board module mainly acts as a processing unit responsible for receiving data for processing and computing. The near-eye display module 520 is electrically connected with the main board module through one of a wire based connection or a wireless connection scheme. In this embodiment, the near-eye display module 520 is electrically connected to the main board module through a transmission cable 560, preferably a charge and sync cable. The near-eye display module 520 mainly acts as an output unit for users and is designed to have the cool look of a sunglass.

The wearable near-eye display device 500 disclosed in the present invention has the above structure that enables the see-through display 521 to have more degree of freedom to adjust a position with respect to the sensor assembly 510, the user's head 20, or to the user's line of sight on multiple and different dimensions.

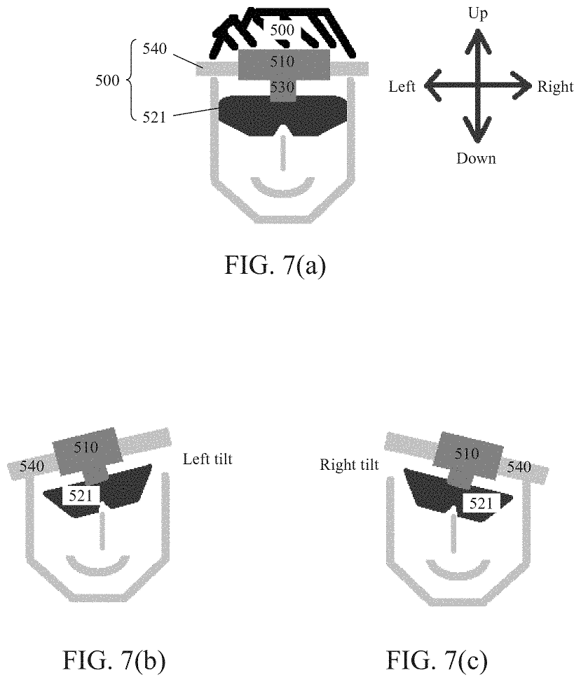

FIG. 7(a) is a front view schematic diagram depicting a up-down position tuning and a left-right position tuning of a position tuning mechanism for the wearable near-eye display device in the second embodiment in accordance with the present invention worn by a user; FIG. 7(b) is a front view schematic diagram depicting a left-tilt position tuning of a position tuning mechanism for the wearable near-eye display device in the second embodiment in accordance with the present invention worn by a user; and FIG. 7(c) is a front view schematic diagram depicting a right-tilt position tuning of a position tuning mechanism for the wearable near-eye display device in the second embodiment in accordance with the present invention worn by a user.

As shown in FIG, 7(a), the attaching unit 540 in the present invention is mainly made of soft, flexible, or elastic materials and the near-eye device 500 is worn onto a user's head 20 through the attaching unit 540. Therefore a user is able to move a position of the near-eye device 500 in relative to the sensor assembly 510 to go up, down, left or right, through straightforwardly adjusting the attaching unit 540, such as a headband or an elastic cord, simply by hands. As shown in FIGS. 7(b) and 7(c), a user is even able to slightly tilt the near-eye device 500 to the right or the left through straightforwardly adjusting the attaching unit 540 simply by using hands as well.

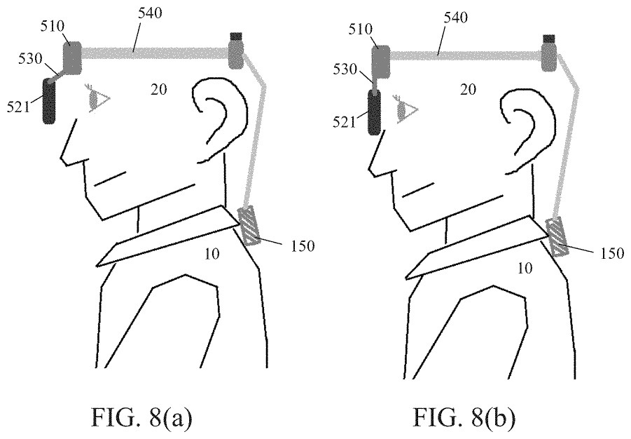

FIG. 8(a) is a side view schematic diagram depicting a forward position tuning of a position tuning mechanism for the wearable near-eye display device in the second embodiment in accordance with the present invention worn by a user; and FIG. 8(b) is a side view schematic diagram depicting a backward position tuning of a position tuning mechanism for the wearable near-eye display device in the second embodiment in accordance with the present invention worn by a user.

As shown in FIG. 8(a), due to the cooperation of all components in the connection and adjustment module 530, including the connection arm 531, the first pivot joint 534 and the second pivot joint 535, a user is able to move a position of the see-through display 521 to go forward with respect to the sensor assembly 510, simply by moving the see-through display 521 slightly away from eyes by hands. On the contrary, as shown in FIG. 8(b) a user is able to move a position of the see-through display 521 to go backward with respect to the sensor assembly 510 or to return to the original position, simply by moving the see-through display 521 more close to eyes by hands.

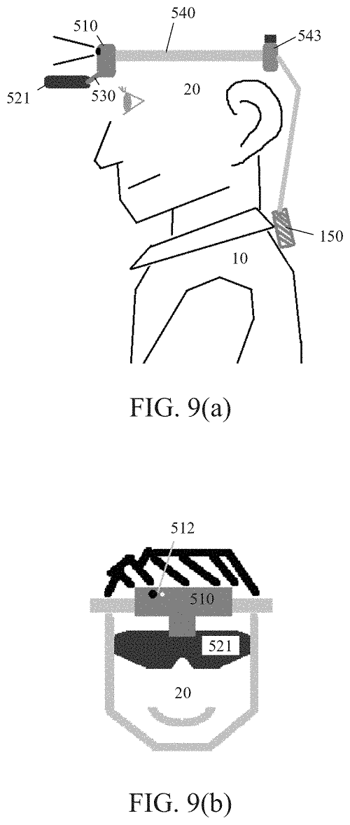

FIG. 9(a) is a side view schematic diagram depicting a flip-up position of a position tuning mechanism for the wearable near-eye display device in the second embodiment in accordance with the present invention worn by a user; and FIG. 9(b) is a front view schematic diagram depicting a flip-down position of a position tuning mechanism for the wearable near-eye display device in the second embodiment in accordance with the present invention worn by a user.

As shown in FIG. 9(a), due to the cooperation of all components in the connection and adjustment module 530, a user is able to flip the see-through display 521 up from the original position, simply by hands, as well as, a user is able to flip down the see-through display 521 to the original position, simply by hands. When the see-through display 521 is currently flipped up or down, all the sensors built in the sensor assembly 510, in particular, the camera, the image sensor, the flash light and the headlight, are able to keep operating without being blocked or interfered by the see-through display 121.

The wearable near-eye display devices used in the present discrete type wearable input and output kit are preferably varifocal and with large angle of view (AOV) so as to create a field of view (FOV) wide and large enough. With a relatively large FOV, the wearable near-eye display device is able to produce and project large display area (virtual screen) showing information (videos, images) for viewers. In the present embodiment, the wearable near-eye display devices 400 and 500 are preferable to have a wide FOV capable of creating a virtual screen having dimension larger than 17 inches for viewers.

The present discrete type wearable input and output kit is particularly appropriate and suitable for applications in a domain of artificial intelligence (AI), such as, an instant translation for multiple languages, an instant optical character recognition, an AI operating system and etc. For example, for the application of AI operating system, a sophisticated artificial intelligence (AI) robot can reside and stay in the operation system on the mobile device as a resident program, and a user can benefits by the resident AI application. For example, a user can talk to a microphone on the wearable near-eye display module or the finger-wearable input device, to give an instruction to the resident AI robot on the mobile device. The resident AI robot on the mobile device is able to have interactions with the user instantly and intelligently, through the wearable near-eye display module or the finger-wearable input device.

As described as above, the present discrete type wearable input and output kit for mobile device is able to make many sci-fi scenarios come true and provides lot of amazing and practical application functions, by simply cooperating with the mobile device. Basically the input and output kit described in the present disclosure opens many new possibilities and opportunities for developers to explore, and many novel applications are to be created.

There are further embodiments provided as follows.

Embodiment 1: A wearable input and output kit for a mobile device includes a finger-wearable input device separated from the mobile device including a finger-wearable input device separated from the mobile device, including a finger sleeve configured to wear on a thumb of a user having a fingerprint identification module to verify an identity of the user, and a button generating an input signal representing a mouse event in response to a press from an index finger of the user, and sending the input signal to the mobile device; and a wearable near-eye display device separated from the mobile device and the finger-wearable input device, receiving an output information from the mobile device and showing the output information for the user to see.

Embodiment 2: The wearable input and output kit as described in Embodiment 1, further includes a signal adaptation module separated from the mobile device, the finger-wearable input device and the wearable near-eye display device, and electrically connected with the mobile device, the finger-wearable input device and the wearable near-eye display device; and a power bank separated from the signal adaptation module, the mobile device, the finger-wearable input device and the wearable near-eye display device, electrically connected with the signal adaptation module, and providing an electric power for the mobile device, the finger-wearable input device and the wearable near-eye display device.

Embodiment 3: The wearable input and output kit as described in Embodiments 1 or 2, wherein the finger-wearable input device sends the input signal to the signal adaptation module and the mobile device receives the input signal sent from the finger-wearable input device through the signal adaptation module.

Embodiment 4: The wearable input and output kit as described in Embodiments 1 or 2, wherein the mobile device sends the output information to the signal adaptation module and the wearable near-eye display device receives the output information sent from the mobile device through the signal adaptation module.

Embodiment 5: The wearable input and output kit as described in Embodiments 1 or 2, wherein the power bank sends an electric power to the signal adaptation module and the mobile device, the finger-wearable input device and the wearable near-eye display device receive the electric power sent from the power bank through the signal adaptation module to operate.

Embodiment 6: The wearable input and output kit as described in Embodiments 1 or 2, wherein the mobile device sends an electric power to the signal adaptation module, the finger-wearable input device and the wearable near-eye display device receive the electric power sent from the mobile device through the signal adaptation module to operate.

Embodiment 7: The wearable input and output kit as described in Embodiments 1, wherein the finger-wearable input device and the wearable near-eye display device exchange data and signals with the mobile device through a wireless communication technology, which the wireless communication technology is selected from one of a Wi-Fi technology, a Bluetooth technology, a Bluetooth low energy technology, a Sub-1G technology, and a ZigBee technology.

Embodiment 8: The wearable input and output kit as described in Embodiment 1, wherein the finger sleeve including a front part positioned at a distal tip of the thumb and a sleeve part worn on a distal portion of the thumb; and an electronic processing module including a gyroscope motion sensor to detect a movement from the finger-wearable input device composed of a pitch action, a roll action and a yaw action occurring on a first axis, a second axis and a third axis respectively in a Cartesian coordinate system, wherein the second axis is set up to be substantively parallel with a longitudinal orientation of the distal portion, so as to reduce the roll action occurring the second axis from the press and torques occurring on the first axis and the third axis when the button is pressed.

Embodiment 9: The wearable input and output kit as described in Embodiment 8, wherein the button is configured on the front part of the finger sleeve, receives the press and acts toward a press direction in response to the press, and electrically connected with the electronic processing module, wherein the press direction is set up to be substantively parallel with a longitudinal orientation of the distal portion, so as to reduce the roll action occurring the second axis from the press and torques occurring on the first axis and the third axis when the button is pressed.

Embodiment 10: The wearable input and output kit as described in Embodiment 8, wherein the finger-wearable input device is driven by the thumb to produce the movement composed of the pitch action, the roll action and the yaw action.

Embodiment 11: The wearable input and output kit as described in Embodiment 8, wherein the finger-wearable input device further includes one of a wrist strap including a first band incorporating a hook pad at a first end and a second band incorporating a loop pad at a second end, wherein the hook pad is detachably attached to the loop pad to cause the wrist strap detachably secured on a wrist of the user; a palm strap connecting the finger sleeve to the wrist strap to cause the finger-wearable input device detachably secured on the thumb and the wrist; and a near field communication module configured on the wrist strap and electrically connected to the electronic processing module.

Embodiment 12: The wearable input and output kit as described in Embodiment 11, wherein one of the finger sleeve, the wrist strap, and the palm strap are made of an elastic fabric.

Embodiment 13: The wearable input and output kit as described in Embodiment 1, wherein the mobile device further includes a USB Type-C port for electrically connecting with the signal adaptation module.

Embodiment 14: The wearable input and output kit as described in Embodiment 1, wherein the wearable near-eye display device further includes one of a sensor assembly including a plurality of electronic sensors, each of which the plurality of electronic sensors are electrically connected with a central processing unit; an attaching unit configured on the sensor assembly to cause the sensor assembly detachably attached to a head of a user; a near-eye display module separated from the sensor assembly, electrically connected with the central processing unit, and showing the output information for the user to see; and a connection and position adjustment module connecting the near-eye display module and the sensor assembly and allowing a position of the near-eye display module with respect to the sensor assembly to be adjusted by the user.

Embodiment 15: The wearable input and output kit as described in Embodiment 14, wherein the plurality of electronic sensors are selected from a group consisting of an image sensor, a voice sensor, a camera lens, a gyroscope sensor, an accelerometer, a magnetometer, a barometer, an altimeter, a barometric altimeter, a light sensor, a charge-coupled sensor, a motion sensor, a temperature sensor, an electronic compass, an infrared sensor and a combination thereof.

Embodiment 16: The wearable input and output kit as described in Embodiment 14, wherein the near-eye display module further includes one of an opaque display and a see-through display, which the see-through display is one of a transparent based display and a semi-transparent based display.

Embodiment 17: The wearable input and output kit as described in Embodiment 14, wherein the connection and position adjustment module further includes a connection arm which has a first end and a second end at which the first and second ends a first pivot joint and a second pivot joint are disposed respectively, and the first pivot joint on the first end is used for connecting to the sensor assembly and the second pivot joint on the second end is used for connecting to the near-eye display module.

Embodiment 18: The wearable input and output kit as described in Embodiment 14, wherein the connection and position adjustment module enables the near-eye display module to move to a position with respect to the user's head to one of a upward direction, a downward direction, a leftward direction, a rightward direction, a forward direction and a backward direction, enables the near-eye display module to tilt to the right or the left with respect to the user's head, and enables the near-eye display module to flip up or flip down based on the connection and position adjustment module as an original point.

Embodiment 19: The wearable input and output kit as described in Embodiment 14, wherein the attaching unit is one selected from a headband, a sweatband, a size band, an adjustable belt, an elastic support arm, a flexible support frame, a support temple, and a silicon support, and further includes one of an end stopper, an end lock, a fastener, a range button, a spring loaded button, a magnetic strap, a magnet, a Velcro strap, a buckle, and a snap.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A wearable input and output kit for a mobile device, comprising:
a finger-wearable input device separated from the mobile device, comprising a finger sleeve configured to wear on a thumb of a user having a fingerprint identification module to verify an identity of the user, and a button generating an input signal representing a mouse event in response to a press from an index finger of the user, and sending the input signal to the mobile device; and
a wearable near-eye display device separated from the mobile device and the finger-wearable input device, receiving an output information from the mobile device and showing the output information for the user to see.

2. The wearable input and output kit as claimed in claim 1, further comprising:
a signal adaptation module separated from the mobile device, the finger-wearable input device and the wearable near-eye display device, and electrically connected with the mobile device, the finger-wearable input device and the wearable near-eye display device; and
a power bank separated from the signal adaptation module, the mobile device, the finger-wearable input device and the wearable near-eye display device, electrically connected with the signal adaptation module, and providing an electric power for the mobile device, the finger-wearable input device and the wearable near-eye display device.

3. The wearable input and output kit as claimed in claim 2, wherein the finger-wearable input device sends the input signal to the signal adaptation module and the mobile device receives the input signal sent from the finger-wearable input device through the signal adaptation module.

4. The wearable input and output kit as claimed in claim 2, wherein the mobile device sends the output information to the signal adaptation module and the wearable near-eye display device receives the output information sent from the mobile device through the signal adaptation module.

5. The wearable input and output kit as claimed in claim 2, wherein the power bank sends an electric power to the signal adaptation module and the mobile device, the finger-wearable input device and the wearable near-eye display device receive the electric power sent from the power bank through the signal adaptation module to operate.

6. The wearable input and output kit as claimed in claim 2, wherein the mobile device sends an electric power to the signal adaptation module, the finger-wearable input device and the wearable near-eye display device receive the electric power sent from the mobile device through the signal adaptation module to operate.

7. The wearable input and output kit as claimed in claims 1, wherein the finger-wearable input device and the wearable near-eye display device exchange data and signals with the mobile device through a wireless communication technology, which the wireless communication technology is selected from one of a Wi-Fi technology, a Bluetooth technology, a Bluetooth low energy technology, a Sub-1G technology, and a ZigBee technology.

8. The wearable input and output kit as claimed in claim 1, wherein the finger-wearable input device further comprises:
the finger sleeve comprising a front part positioned at a distal tip of the thumb and a sleeve part worn on a distal portion of the thumb; and
an electronic processing module comprising a gyroscope motion sensor to detect a movement from the finger-wearable input device composed of a pitch action, a roll action and a yaw action occurring on a first axis, a second axis and a third axis respectively in a Cartesian coordinate system, wherein the second axis is set up to be substantively parallel with a longitudinal orientation of the distal portion, so as to reduce the roll action occurring the second axis from the press and torques occurring on the first axis and the third axis when the button is pressed.

9. The wearable input and output kit as claimed in claim 8, wherein the button is configured on the front part of the finger sleeve, receives the press and acts toward a press direction in response to the press, and electrically connected with the electronic processing module, wherein the press direction is set up to be substantively parallel with a longitudinal orientation of the distal portion, so as to reduce the roll action occurring the second axis from the press and torques occurring on the first axis and the third axis when the button is pressed.

10. The wearable input and output kit as claimed in claim 8, wherein the finger-wearable input device is driven by the thumb to produce the movement composed of the pitch action, the roll action and the yaw action.

11. The wearable input and output kit as claimed in claim 8, wherein the finger-wearable input device further comprises one of:
a wrist strap comprising a first band incorporating a hook pad at a first end and a second band incorporating a loop pad at a second end, wherein the hook pad is detachably attached to the loop pad to cause the wrist strap detachably secured on a wrist of the user;
a palm strap connecting the finger sleeve to the wrist strap to cause the finger-wearable input device detachably secured on the thumb and the wrist; and
a near field communication module configured on the wrist strap and electrically connected to the electronic processing module.

12. The wearable input and output kit as claimed in claim 11, wherein one of the finger sleeve, the wrist strap, and the palm strap are made of an elastic fabric.

13. The wearable input and output kit as claimed in claim 1, wherein the mobile device further comprises a USB Type-C port for electrically connecting with the signal adaptation module.

14. The wearable input and output kit as claimed in claim 1, wherein the wearable near-eye display device further comprises one of:
a sensor assembly comprising a plurality of electronic sensors, each of which the plurality of electronic sensors are electrically connected with a central processing unit;
an attaching unit configured on the sensor assembly to cause the sensor assembly detachably attached to a head of a user;
a near-eye display module separated from the sensor assembly, electrically connected with the central processing unit, and showing the output information for the user to see; and
a connection and position adjustment module connecting the near-eye display module and the sensor assembly and allowing a position of the near-eye display module with respect to the sensor assembly to be adjusted by the user.

15. The wearable input and output kit as claimed in claim 14, wherein the plurality of electronic sensors are selected from a group consisting of an image sensor, a voice sensor, a camera lens, a gyroscope sensor, an accelerometer, a magnetometer, a barometer, an altimeter, a barometric altimeter, a light sensor, a charge-coupled sensor, a motion sensor, a temperature sensor, an electronic compass, an infrared sensor and a combination thereof.

16. The wearable input and output kit as claimed in claim 14, wherein the near-eye display module further comprises one of an opaque display and a see-through display, which the see-through display is one of a transparent based display and a semi-transparent based display.

17. The wearable input and output kit as claimed in claim 14, wherein the connection and position adjustment module further comprises a connection arm which has a first end and a second end at which the first and second ends a first pivot joint and a second pivot joint are disposed respectively, and the first pivot joint on the first end is used for connecting to the sensor assembly and the second pivot joint on the second end is used for connecting to the near-eye display module.

18. The wearable input and output kit as claimed in claim 14, wherein the connection and position adjustment module enables the near-eye display module to move to a position with respect to the user's head to one of a upward direction, a downward direction, a leftward direction, a rightward direction, a forward direction and a backward direction, enables the near-eye display module to tilt to the right or the left with respect to the user's head, and enables the near-eye display module to flip up or flip down based on the connection and position adjustment module as an original point.

19. The wearable input and output kit as claimed in claim 14, wherein the attaching unit is one selected from a headband, a sweatband, a size band, an adjustable belt, an elastic support arm, a flexible support frame, a support temple, and a silicon support, and further comprises one of an end stopper, an end lock, a fastener, a range button, a spring loaded button, a magnetic strap, a magnet, a Velcro strap, a buckle, and a snap.
